(19) United States
(12) Patent Application Publication
(10) Pub. No.: US 2010/0117920 A1
(43) Pub. Date: May 13, 2010

(54) MULTIBAND ANTENNA DEVICE

(76) Inventors: Wei-Chih Ku, Taipei (TW); Chuan-Chian Huang, Taipei (TW); Ching-Chung Tang, Taipei (TW)

Correspondence Address: Muncy, Geissler, Olds & Lowe, PLLC, P.O. BOX 1364, FAIRFAX, VA, 22038-1364, US

(21) Appl. No.: 12/478,464

(22) Filed: Jun. 4, 2009

(30) Foreign Application Priority Data
Nov. 11, 2008 (TW) 097143474

(51) Int. Cl. H01Q 5/00; H01Q 1/50; H01Q 21/00

(52) U.S. Cl. 343/853

(57) ABSTRACT

A multiband antenna device includes a first antenna, a second antenna, and a switch. The switch is connected with the first antenna and the second antenna, respectively, and it controls a conducting state between the first antenna and the second antenna. When the switch turns off, the multiband antenna device receives and transmits a first frequency band signal by the first antenna. When the switch turns on, the multiband antenna device receives and transmits a second frequency band signal by the first antenna and the second antenna. In the invention, signals in different frequency bands can be received, and the volume of a design circuit can be reduced. Reflecting energy of the signals feeding in the antennas can be reduced by adjusting impedance values of the antennas to make the multiband antenna device achieve an optimized receiving and transmitting state.

### BACKGROUND OF THE INVENTION

1. Field of the Invention

The invention relates to a multiband antenna device and, more particularly, to a multiband antenna device using a switch to control a conducting state between two antennas to receive signals in different frequency bands.

2. Description of the Related Art

Conventional wireless devices have different kinds of wireless communication applications, such as a global system for mobile communications (GSM), wideband code division multiple access (W-CDMA), wireless fidelity (Wi-Fi), bluetooth, a global positioning system (GPS), digital video broadcasting (DVB) and so on. Therefore, if the above application techniques are integrated in a same communication device, the performance of each wireless communication application may be not well, or considering the performance, the size of the wireless device has to increase. Thus, the performance and the size can not be considered at the same time.

Considering multiband wireless communication applications, the antenna design of the conventional wireless devices is to design an antenna for a frequency band, which not only causes a complex circuit design, but also causes a large circuit area. Thus, the volume of the wireless device can not decrease easily.

### BRIEF SUMMARY OF THE INVENTION

The invention provides a multiband antenna device. The multiband antenna device utilizes a switch to control a conducting state between two antennas. Thus, different antennas can receive signals in different frequency bands, respectively, and the volume of a design circuit can be reduced. Furthermore, reflecting energy of the signals feeding in the antennas can be reduced by adjusting the impedance values of the antennas to make reception and transmission of the antennas achieve an optimized state.

In the invention, the multiband antenna device includes a first antenna, a second antenna, and a switch. The first antenna has a first terminal and a second terminal, and the first terminal is a feed-in point of signals. The second antenna has a first terminal and a second terminal, and the second terminal of the first antenna and the first terminal of the second antenna are connected by the switch. The switch is used to control a conducting state between the first antenna and the second antenna.

When the switch turns off, the first antenna is not conducted to the second antenna, which represents that the multiband antenna device may only receive and transmit the signals by the first antenna. At that moment, the wavelength of the signals received and transmitted by the multiband antenna device is equal to a length λ1 of the first antenna. The receiving and transmitting frequency is a first frequency f1 equal to f₁=ν/λ₁, and the ν is a velocity of electromagnetic waves.

When the switch turns on, the first antenna is conducted to the second antenna. It represents that multiband antenna device may receive and transmit the signals by both the first antenna and the second antenna. At that moment, the wavelength of the signals received and transmitted by the multiband antenna device is equal to the sum of the length λ1 of the first antenna and a length λ2 of the second antenna, that is, λ1+λ2. The receiving and transmitting frequency is a second frequency f2 equal to f₂=ν/(λ₁+λ₂), and the ν is the velocity of the electromagnetic waves.

In the invention, the multiband antenna device utilizes a switch to control 5 the conducting state between the two antennas to receive signals in different frequency bands. With increase of the number of the antenna and the switch, the antenna device of the invention can receive signals in more frequency bands.

In the invention, the switch includes a controller and a diode. The diode is connected with the first antenna and the second antenna, respectively, and the controller is used to control the conducting state of the diode. The controller may be a programmable logic circuit (PLC), and a software program may be written into the controller to control the diode.

In the invention, the reflecting energy of the signals feeding in the antennas can be reduced by adjusting the impedance values of the antennas to make signal reception and transmission of the multiband antenna device achieve an optimized effect.

Compared with the conventional technology, the invention has the following advantages.

A single antenna device is used to receive multiband signals to reduce the volume of the antenna device.

The reflecting energy of feed-in signals can be reduced by adjusting the impedance values of the antennas to make the signal reception and transmission achieve an optimized effect.

These and other features, aspects, and advantages of the present invention will become better understood with regard to the following description, appended claims, and accompanying drawings.

### BRIEF DESCRIPTION OF THE DRAWINGS

FIG. 1A is a schematic diagram of a multiband antenna device according to a first embodiment of the invention;

FIG. 1B is a schematic diagram of a multiband antenna device according to a second embodiment of the invention; and

FIG. 1C is a schematic diagram of a multiband antenna device according to a third embodiment of the invention.

### DETAILED DESCRIPTION OF THE EMBODIMENTS

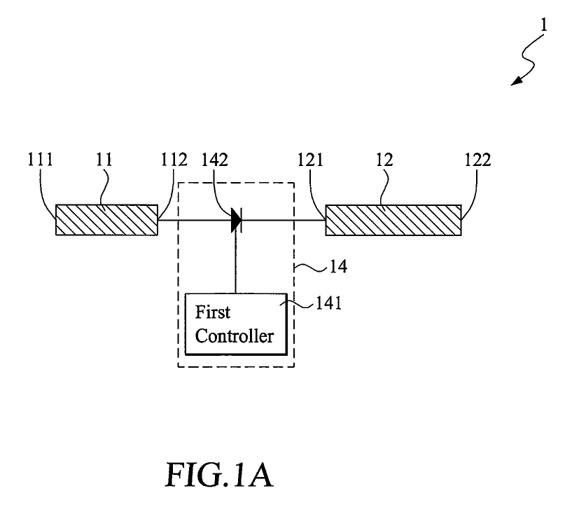

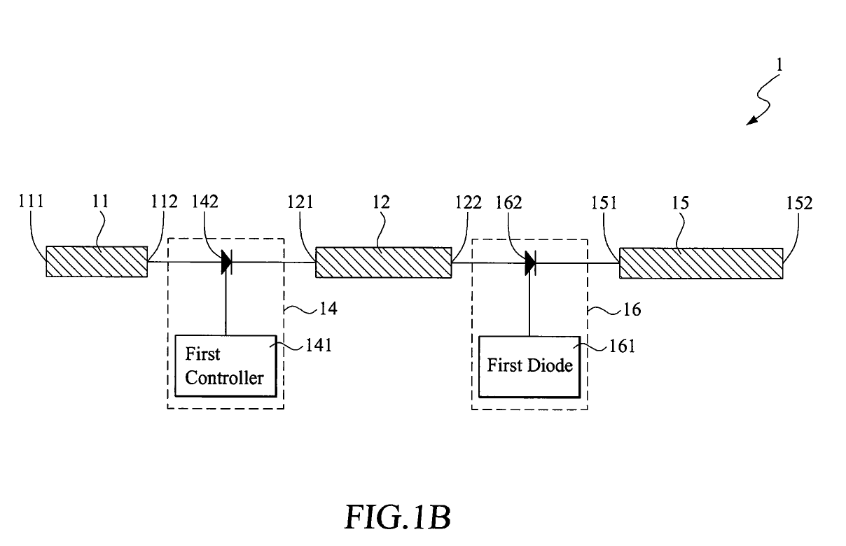

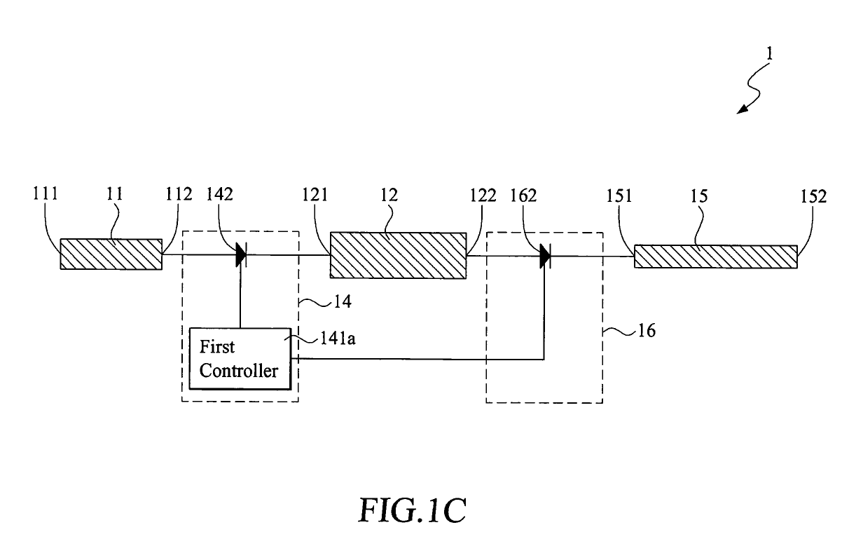

As shown in FIG. 1A, FIG. 1A is a schematic diagram of a multiband antenna device according to a first embodiment of the invention. A multiband antenna device 1 includes a first antenna 11, a second antenna 12, and a first switch 14.

The first antenna 11 has a first terminal 111 and a second terminal 112, and the first terminal 111 is a feed-in point. The second antenna 12 also has a first terminal 121 and a second terminal 122. The first switch 14 includes a first controller 141 and a first diode 142.

In the first switch 14, two terminals of the first diode 142 are connected with the second terminal 112 of the first antenna 11 and the first terminal 121 of the second antenna 12, respectively, and the first controller 141 controls conduction of the first diode 142. The first controller 141 may be a programmable logic circuit (PLC), and it may control via a software program.

The multiband antenna device 1 of the embodiment utilizes an on state and an off state of the first switch 14 to adjust a receiving and transmitting frequency band of the multiband antenna device 1. In the multiband antenna device 1 of the embodiment, the transmitting velocity of electromagnetic waves is ν, the length of the first antenna 11 is λ1, and the length of the second antenna 12 is λ2.

When the first switch 14 turns off, the first antenna 11 is not conducted to the second antenna 12. It represents that the multiband antenna device 1 can only receive and transmit signals by the first antenna 11. At that moment, the wavelength of the signals received and transmitted by the multiband antenna device 1 is equal to the length λ1 of the first antenna 11. The receiving and transmitting frequency is a first frequency f1 equal to f₁=ν/λ₁, and the ν is the velocity of the electromagnetic waves.

When the first switch 14 turns on, the first antenna 11 is conducted to the second antenna 12. It represents that the multiband antenna device 1 can receive and transmit the signals by the first antenna 11 and the second antenna 12. At that moment, the wavelength of the signals received and transmitted by the multiband antenna device 1 is equal to the sum of the length λ1 of the first antenna 11 and the length λ2 of the second antenna 12, that is, λ1+λ2. The receiving and transmitting frequency is a second frequency f2 equal to f₂=ν/(λ₁+λ₂), and the ν is the velocity of the electromagnetic waves.

In the embodiment, the first antenna 11 and the second antenna 12 are integrated in a same antenna device, and the on state and the off state of the first switch 14 are used to control the conducting state between the two antennas to receive signals in two different frequency bands.

In other embodiments, a plurality of antennas may also be integrated in a same antenna device in a serial mode, and a plurality of switches may be used to cooperate with the antennas to control the conduction of the antennas to receive signals in different frequency bands.

As shown in FIG. 1B, FIG. 1B is a schematic diagram of a multiband antenna device 1 according to a second embodiment of the invention. The multiband antenna device 1 includes a first antenna 11, a second antenna 12, a third antenna 15, a first switch 14, and a second switch 16. The structures, the elements and the functions of the first antenna 11, the second antenna 12, and the first switch 14 are described as in the first embodiment. Therefore, they are not described for a concise purpose. The third antenna 15 and the second switch 16 are described herein.

The third antenna 15 has a first terminal 151 and a second terminal 152. The second switch 16 includes a second controller 161 and a second diode 162.

In the second controller 16, two terminals of the second diode 162 are connected with the second terminal 122 of the second antenna 12 and the first terminal 151 of the third antenna 15, respectively, and the second controller 161 controls the conduction of the second diode 162. The second controller 161 may be a programmable logic circuit (PLC), and a software program may be loaded to perform a program control.

In the multiband antenna device 1 of the embodiment, the transmitting velocity of the electromagnetic waves is ν, the length of the first antenna 11 is λ1, the length of the second antenna 12 is λ2, and the length of the third antenna 15 is λ3.

When the first switch 14 turns off, the first antenna 11 is not conducted to the second antenna 12. It represents that the multiband antenna device 1 can only receive and transmit signals by the first antenna 11. At that moment, the wavelength of the signals received and transmitted by the multiband antenna device 1 is equal to the length λ1 of the first antenna 11. The receiving and transmitting frequency is a first frequency f1 equal to f₁=ν/λ₁, and the ν is the velocity of electromagnetic waves.

When the first switch 14 turns on and the second switch 16 turns off, the second antenna 12 is not conducted to the third antenna 15. It represents that the multiband antenna device 1 can receive and transmit the signals by the first antenna 11 and the second antenna 12. At that moment, the wavelength of the signals received and transmitted by the multiband antenna device 1 is equal to the sum of the length of the first antenna 11 and the length of the second antenna 12, that is, λ1+λ2. The receiving and transmitting frequency is a second frequency f2 equal to f₂=ν/(λ₁+λ₂), and the ν is the velocity of the electromagnetic waves.

When the first switch 14 and the second switch 16 both turn on, the second antenna 12 is conducted to the first antenna 11 and the third antenna 15, respectively. It represents that the multiband antenna device 1 can receive and transmit the signals by the first antenna 11, the second antenna 12, and the third antenna 15. At that moment, the wavelength of the signals received and transmitted by the multiband antenna device 1 is equal to the sum of the length of the first antenna 11, the length of the second antenna 12 and the length of the third antenna 15, that is, λ1+λ2+λ3. The receiving and transmitting frequency is a third frequency f3 equal to f₃=ν/(λ₁+λ₂+λ₃), and the ν is the velocity of the electromagnetic waves.

In the embodiment, the first antenna 11, the second antenna 12 and the third antenna 15 are integrated in a same antenna device, and the on state and the off state of the first switch 14 and the second switch 16 are used to control the conducting states of the three antennas to receive signals in three different frequency bands, respectively.

As shown in FIG. 1C, FIG. 1C is a schematic diagram of a multiband antenna device 1 according to a third embodiment of the invention. The multiband antenna device 1 includes a first antenna 11, a second antenna 12, a third antenna 15, a first switch 14, and a second switch 16.

The structures, the elements and the functions of the first antenna 11, the second antenna 12, and the third antenna 15 are described as in the second embodiment. Therefore, they are not described for a concise purpose. The first switch 14 and the second switch 16 are described herein.

The first switch 14 includes a first controller 141a and a first diode 142. The second switch 16 has a second diode 162.

The second diode 162 of the second switch 16 is connected with the second terminal 122 of the second antenna 12 and the first terminal 151 of the third antenna 15, and it is also connected with the first controller 141a. The first diode 142 of the first switch 14 is connected with the second terminal 112 of the first antenna 11 and the first terminal 121 of the second antenna 12. The first controller 141 a can control the conduction of the first diode 142 and the second diode 162, respectively. The first controller 141a may be a programmable logic circuit (PLC), and a software program may be loaded to control the conduction of the first diode 142 and the second diode 162, respectively.

In the multiband antenna device 1 of the embodiment, the velocity of the electromagnetic waves is ν, the length of the first antenna 11 is λ1, the length of the second antenna 12 is λ2, and the length of the third antenna 15 is λ3.

When the first switch 14 controls the first diode 142 to turn off, the first antenna 11 is not conducted to the second antenna 12. It represents that the multiband antenna device can only receive and transmit signals by the first antenna 11. At that moment, the wavelength of the signals received and transmitted by the multiband antenna device 1 is equal to the length λ1 of the first antenna 11. The receiving and transmitting frequency is a first frequency f1 equal to f₁=ν/λ₁, and the ν is the velocity of the electromagnetic waves.

When the first switch 14 controls the first diode 142 to turn on and controls the second diode 162 to turn off, the second antenna 12 is not conducted to the third antenna 15. It represents that the multiband antenna device can only receive and transmit the signals by the first antenna 11 and the second antenna 12. At that moment, the wavelength of the signals received and transmitted by the multiband antenna device 1 is equal to the sum of the length of the first antenna 11 and the second antenna 12, that is, λ1+λ2. The receiving and transmitting frequency is a second frequency f2 equal to f₂=ν/(λ₁+λ₂), and the ν is the velocity of the electromagnetic waves.

When the first switch 14 controls the first diode 142 and the second diode 162 to turn on, the second antenna 12 is conducted to the first antenna 11 and the third antenna 15, respectively. It represents that the multiband antenna device 1 can receive and transmit the signals by the first antenna 11, the second antenna 12, and the third antenna 15. At that moment, the wavelength of the signals received and transmitted by the multiband antenna device 1 is equal to the sum of the lengths of the first antenna 11, the second antenna 12 and the third antenna 15, that is, λ1+λ2+λ3. The receiving and transmitting frequency is a third frequency f3 equal to f₃=ν/(λ₁+λ₂+λ₃), and the ν is the velocity of the electromagnetic waves.

In the embodiment, the first antenna 11, the second antenna 12 and the third antenna 15 are integrated in a same antenna device, and the on state and the off state of the first switch 14 and the second switch 16 are used to control the conduction of the three antennas to receive signals in three different frequency bands, respectively. Furthermore, in the embodiment, the first controller is used to control two diodes, respectively. Compared with the second embodiment, in the embodiment, a controller is omitted.

As shown in FIG. 1C, the impedance values of the antennas of the multiband antenna device 1 can be adjusted by adjusting the lengths, the widths or the materials of the antennas. The adjustment of the impedance values is used to increase the feed-in energy of the signals and to decrease the reflecting energy to achieve an optimized receiving and transmitting effect of the multiband antenna device. Thus, the receiving and transmitting performance of the multiband antenna device 1 can achieve an optimization.

Therefore, in the invention, a single antenna device can provide multiband signals, and the volume of the design circuit can be reduced at the same time. In addition, in the invention, the impedance values of the antennas can be adjusted to make the multiband antenna device achieve the optimized single receiving and transmitting performance. Thus, the feed-in signals can increase, and the reflecting energy can decrease.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A multiband antenna device comprising:
a first antenna having a first terminal and a second terminal;
a second antenna having a first terminal and a second terminal; and
a first switch connected with the second terminal of the first antenna and the first terminal of the second antenna, respectively, and controlling conducting states of the first antenna and the second antenna;
wherein when the first switch turns off, the multiband antenna device receives and transmits a first frequency band signal by the first antenna, and when the first switch turns on, the multiband antenna device receives and transmits a second frequency band signal by both the first antenna and the second antenna.

2. The multiband antenna device according to claim 1, wherein the first terminal of the first antenna is a feed-in point.

3. The multiband antenna device according to claim 1, wherein the first antenna and the second antenna have different impedance, respectively.

4. The multiband antenna device according to claim 1, wherein the first switch comprises a first diode and a first controller, and the first controller controls the conducting state of the first diode.

5. The multiband antenna device according to claim 1, further comprising:
a third antenna having a first terminal and a second terminal; and
a second switch connected with the second terminal of the second antenna and the first terminal of the third antenna, respectively, and controlling conducting states of the second antenna and the third antenna;
wherein when the first switch turns on and the second switch turns off, the multiband antenna device receives and transmits the second frequency band signal by both the first antenna and the second antenna, and when the first switch turns on and the second switch turns on, the multiband antenna device receives and transmits a third frequency band signal by the first antenna, the second antenna, and the third antenna.

6. The multiband antenna device according to claim 5, wherein the first antenna, the second antenna, and the third antenna have different impedance, respectively.

7. The multiband antenna device according to claim 5, wherein the second switch comprises a second diode and a second controller, and the second controller controls the conducting state of the second diode.

8. The multiband antenna device according to claim 5, wherein the second switch comprises a second diode connected with the first controller, and the first controller controls the conducting states of the second diode.

9. The multiband antenna device according to claim 7, wherein the first switch is a programmable logic circuit (PLC), and the first switch controls the conducting states of the second diode by a software program.
